(19) United States
(12) Patent Application Publication
(10) Pub. No.: US 2024/0267935 A1
(43) Pub. Date: Aug. 8, 2024

(54) APPARATUSES FOR INDICATING SIDELINK TRANSMISSION RESOURCE

(71) Applicant: GUANGDONG OPPO MOBILE TELECOMMUNICATIONS CORP., LTD., Dongguan (CN)

(72) Inventors: Zhenshan ZHAO, Dongguan (CN); Shichang ZHANG, Dongguan (CN); Huei-Ming LIN, Taipei (TW)

(21) Appl. No.: 18/636,869

(22) Filed: Apr. 16, 2024

Related U.S. Application Data
(63) Continuation of application No. PCT/CN2021/125795, filed on Oct. 22, 2021.

(51) Int. Cl. H04W 72/25

(52) U.S. Cl. CPC H04W 72/25

(57) ABSTRACT

Apparatuses for indicating sidelink transmission resource are provided. The apparatus includes: a processor, a transceiver connected to the processor, and a memory for storing instructions executable by the processor. The processor is configured to load and execute the instructions to control the transceiver to transmit sidelink control information (SCI) to a second terminal. The SCI indicates a transmission resource for a physical sidelink shared channel (PSSCH), and the transmission resource for the PSSCH is based on an IRB.

### CROSS-REFERENCE TO RELATED APPLICATION

This application is a continuation of International Patent Application No. PCT/CN2021/125795, filed on Oct. 22, 2021, the disclosure of which is hereby incorporated by reference in its entirety.

### BACKGROUND

In order to implement a direct communication between terminals in a Vehicle to everything (V2X) system, a sidelink (SL) transmission mode has been introduced.

### SUMMARY

The disclosure relates to the field of vehicle-to-everything communications, in particular to a method and apparatus for indicating sidelink transmission resource, a device and a storage medium, which can realize a sidelink resource indication based on an interlaced resource block (IRB) in a sidelink over unlicensed spectrum (SL-U) scene. The technical solutions are described as follows.

In an aspect of the disclosure, there is provided an apparatus for indicating sidelink transmission resource, which includes: a processor, a transceiver connected to the processor, and a memory for storing instructions executable by the processor.

The processor is configured to load and execute the instructions to control the transceiver to transmit sidelink control information (SCI) to a second terminal. The SCI indicates a transmission resource for a physical sidelink shared channel (PSSCH), and the transmission resource for the PSSCH is based on an IRB.

In an aspect of the disclosure, there is provided an apparatus for indicating sidelink transmission resource, which includes: a processor, a transceiver connected to the processor, and a memory for storing instructions executable by the processor.

The processor is configured to load and execute the instructions to control the transceiver to receive SCI from a first terminal. The SCI indicates a transmission resource for a PSSCH, and the transmission resource for the PSSCH is based on an IRB.

In an aspect of the disclosure, there is provided an apparatus for indicating sidelink transmission resource, which includes: a processor, a transceiver connected to the processor, and a memory for storing instructions executable by the processor.

The processor is configured to load and execute the instructions to control the transceiver to transmit a configuration signaling to a first terminal, the configuration signaling is used for configuring a transmission resource for SCI and a transmission resource for a PSSCH, and the transmission resource carrying the SCI and the transmission resource carrying the PSSCH are based on an IRB.

### BRIEF DESCRIPTION OF THE DRAWINGS

In order to illustrate the technical solutions in the embodiments of the disclosure more clearly, drawings to be used in the description of the embodiments will be briefly described below. It will be apparent that the drawings described below are only some embodiments of the disclosure, and other drawings may also be obtained from these drawings without any creative effort for those of ordinary skilled in the art.

FIG. 1 is a schematic diagram illustrating a transmission mode in a sidelink in a related art of the disclosure.

FIG. 2 is a block diagram illustrating a physical layer structure of NR-V2X in a related art of the disclosure.

FIG. 3 is a schematic diagram illustrating a frequency domain structure of an IRB in a related art of the disclosure.

FIG. 4 is a time-frequency schematic diagram of an IRB-based sidelink resource partition provided by an exemplary embodiment of the disclosure.

FIG. 5 is a time-frequency schematic diagram of an IRB-based sidelink resource partition provided by an exemplary embodiment of the disclosure.

FIG. 6 is a block diagram of a communication system supporting sidelink transmission provided by an exemplary embodiment of the disclosure.

FIG. 7 is a flowchart of a method for indicating sidelink transmission resource provided by an exemplary embodiment of the disclosure.

FIG. 8 is a time-frequency schematic diagram of a transmission resource for one PSSCH provided by an exemplary embodiment of the disclosure.

FIG. 9 is a time-frequency schematic diagram of a transmission resource for two PSSCHs provided by an exemplary embodiment of the disclosure.

FIG. 10 is a time-frequency schematic diagram of a transmission resource for three PSSCHs provided by an exemplary embodiment of the disclosure.

FIG. 11 is a flowchart of a method for indicating sidelink transmission resource provided by an exemplary embodiment of the disclosure.

FIG. 12 is a flowchart of a method for indicating sidelink transmission resource provided by an exemplary embodiment of the disclosure.

FIG. 13 is a flowchart of a method for indicating sidelink transmission resource based on Mode 1 provided by an embodiment of the disclosure.

FIG. 14 is a flowchart of a method for indicating sidelink transmission resource based on Mode 2 provided by an embodiment of the disclosure.

FIG. 15 is a structure block diagram of an apparatus for indicating sidelink transmission resource provided by an exemplary embodiment of the disclosure.

FIG. 16 is a structure block diagram of an apparatus for indicating sidelink transmission resource provided by an exemplary embodiment of the disclosure.

FIG. 17 is a structure block diagram of an apparatus for indicating sidelink transmission resource provided by an exemplary embodiment of the disclosure.

FIG. 18 is a structural schematic diagram of a communication device provided by an exemplary embodiment of the disclosure.

### DETAILED DESCRIPTION

In order to make purposes, technical solutions and advantages of the disclosure clearer, the embodiments of the disclosure will be described in further detail below in conjunction with the accompanying drawings.

First of all, the nouns involved in the embodiments of the disclosure are briefly introduced.

### Vehicle to Everything (V2X)

It is a key technology in an intelligent transportation system in the future, and mainly studies a vehicle data transmission scheme based on 3GPP communication protocol. V2X communication includes vehicle to vehicle (V2V) communication, vehicle to infrastructure (V2I) communication and vehicle to people (V2P) communication. V2X application will improve driving safety, reduce congestion and vehicle energy consumption, and improve traffic efficiency.

### SideLink (SL) Transmission

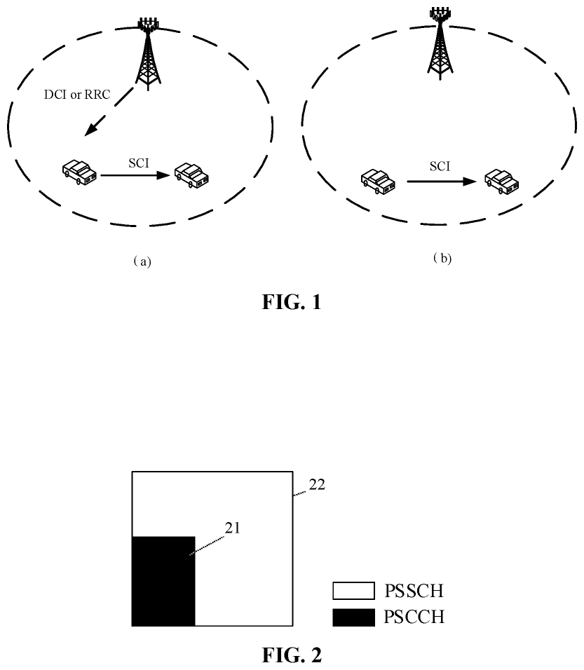

It is a device-to-device communication mode with high spectrum efficiency and low transmission delay. In 3GPP, two transmission modes in the sidelink are defined: Mode 1 and Mode 2. As shown in (a) of FIG. 1, in Mode 1, resources used by a terminal during transmission are allocated by a base station through a downlink, and the terminal transmits data on the sidelink based on the resources allocated by the base station. The base station may allocate resources for a single transmission or semi-static transmission for the terminal. As shown in (b) of FIG. 1, in Mode 2, the terminal independently selects one or more resources from a resource pool to transmit data. Specifically, the terminal may select transmission resources in the resource pool by sensing or random selection. V2X uses the sidelink for communication.

In New Radio (NR)-V2X, automatic driving needs to be supported, so higher requirements are put forward for data interaction between vehicles, such as higher throughput, lower delay, higher reliability, larger coverage and more flexible resource allocation.

### Physical Layer Structure of NR-V2X

As shown in FIG. 2, a physical sidelink control channel (PSCCH) 21 for transmitting SCI and a PSSCH 22 for transmitting data are transmitted simultaneously. In Mode B in NR-V2X, the terminal independently selects resources in the resource pool to transmit data. Resource reservation is a prerequisite for resource selection. Resource reservation means that the terminal transmits first SCI in PSCCH to reserve the resources to be used next. In NR-V2X, resource reservation within a single transport block (TB) is supported, and resource reservation between two TBs is also supported.

### IRB Structure in NR-U System

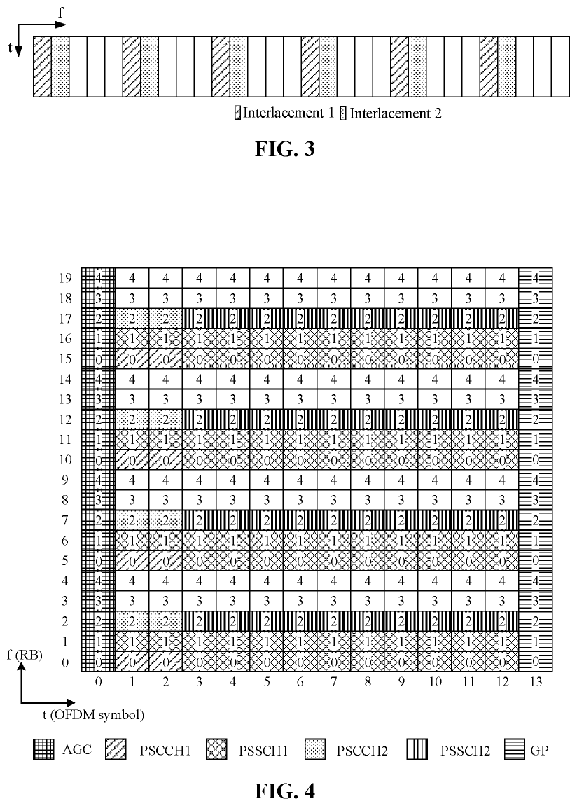

NR-U is studied in 3GPP R16 version. Communication in an unlicensed spectrum usually needs to meet corresponding regulatory requirements. For example, if the terminal intends to communicating in the unlicensed spectrum, the spectrum occupied by the terminal needs to be greater than or equal to 80% of a system bandwidth. Therefore, in order to enable more users to access the channel in the same time as possible, a resource allocation mode based on IRB is defined in NR-U. An IRB resource includes N physical resource blocks (PRBs), and a total of M IRB resources are included in the spectrum. The PRBs included in the m-th IRB are {m, M+m, 2M+m, 3M+m, . . . }. As shown in FIG. 3, the system bandwidth includes 30 RBs containing 5 interlacements (i.e., M=5), each interlacement includes 6 RBs (i.e., N=6). Adjacent RBs in one interlacement have a same frequency domain spacing, that is, 5 RBs apart.

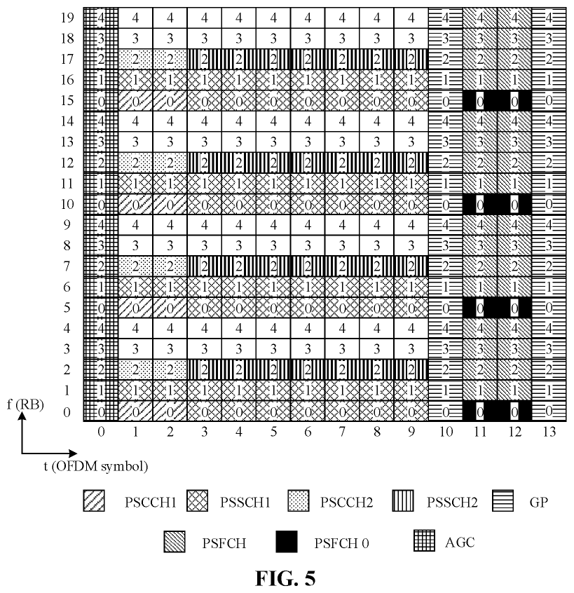

In a sidelink over unlicensed spectrum (SL-U) system, if a resource allocation granularity based on the IRB is adopted, the channels such as the PSCCH, the PSSCH and a physical sidelink feedback channel (PSFCH) of the SL-U system are all based on the IRB structure. At this time, a frame structure of the SL-U system is shown in FIGS. 4 and 5. FIG. 4 is a schematic diagram of the frame structure including only the PSCCH and the PSSCH but not the PSFCH in a slot. FIG. 5 is a schematic diagram of the frame structure including the PSCCH, the PSSCH and the PSFCH in the slot. In FIGS. 4 and 5, the system bandwidth includes 20 RBs configured with 5 IRB resources, i.e., M=5, and each IRB resource includes 4 RBs. The number in the box represents an IRB index. In FIG. 4, the system configures the PSCCH to occupy one IRB resource and occupy two orthogonal frequency-division multiplexing (OFDM) symbols in the time domain. The PSSCH takes the IRB as a granularity, a first symbol in the slot is an automatic gain control (AGC) symbol, and a last symbol is a guard period (GP) symbol. In FIG. 4, PSSCH1 occupies IRB #0 and IRB #1, and the PSCCH1 corresponding to the PSSCH1 occupies IRB #0. PSSCH2 occupies IRB #2, and the PSCCH2 corresponding to the PSSCH2 also occupies IRB #2. FIG. 5 is a schematic diagram of a slot structure including PSFCH resources, where one PSFCH occupies one IRB resource, such as PSFCHO occupying IRB #0. One PSFCH occupies two OFDM symbols. The first time domain symbol in the two figures is the AGC symbol, and data in this symbol may be a duplicate of data in the second symbol. The last symbol is the GP symbol. In FIG. 5, the OFDM symbol before the first OFDM symbol occupied by the PSFCH is a GP symbol.

It should be noted that the resources occupied by the second-order SCI and the resources occupied by PSCCH demodulation reference signal (DMRS) and PSSCH DMRS are not depicted in FIGS. 4 and 5 for simplicity.

FIG. 6 illustrates a block diagram of a communication system supporting sidelink transmission provided by an exemplary embodiment of the disclosure. The communication system may be a schematic diagram of a non-roaming 5G system architecture, which may be applied to V2X services using a D2D technology.

The system architecture includes a data network (DN), in which a V2X application server required for the V2X services is arranged. The system architecture further includes a 5G core network, and network functions of the 5G core network include: a unified data management (UDM), a policy control function (PCF), a network exposure function (NF), an application function (AF), a unified data repository (UDR), an access and mobility management function (AMF), a session management function (SMF) and a user plane function (UPF).

The system architecture further includes a new generation-radio access network (NG-RAN) and four terminals (i.e., terminals 1 to 4) shown by example, and each terminal is provided with a V2X application. The RAN is provided with one or more access network devices, such as a base station (gNB). The terminal performs uplink transmission to the access network device.

In the system architecture, a data network is connected with the UPF in the 5G core network through an N6 reference point, and the V2X application server is connected with the V2X application in the terminal through a V1 reference point. The RAN is connected with the AMF and the UPF in the 5G core network, and the RAN is connected with terminal 1 and terminal 5 through Uu reference points respectively. Sidelink transmission is carried out between multiple terminals through PC5 reference points, and multiple V2X applications are connected through V5 reference points. The above reference points may also be referred to as “interfaces”.

In a scenario of the unlicensed spectrum (or shared spectrum), how to realize a resource indication for a sidelink transmission resource is an urgent technical problem to be solved.

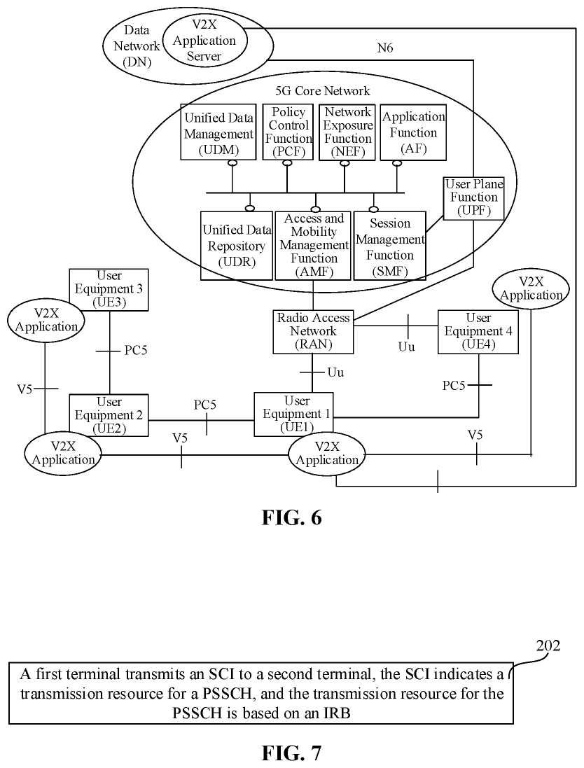

FIG. 7 illustrates a flowchart of a method for indicating sidelink transmission resource provided by an exemplary embodiment of the disclosure. The embodiment is exemplified by applying this method to at least two terminals shown in FIG. 6. The method includes the following operation.

At operation 202, a first terminal transmits SCI to a second terminal. The SCI indicates a transmission resource for a PSSCH, and the transmission resource for the PSSCH is based on an IRB.

In Mode 1, the transmission resources carrying the SCI and the transmission resources carrying the PSSCH are both indicated to the first terminal by a network device. In Mode 2, the transmission resource carrying the SCI and the transmission resource carrying the PSSCH are independently selected by the first terminal in a resource pool. These transmission resources are also referred to as “sidelink transmission resources”.

Exemplary, a frequency domain starting resource corresponding to the transmission resource carrying the SCI is the same as a frequency domain starting resource corresponding to the transmission resource carrying the PSSCH.

Exemplary, if the transmission resource carrying the PSSCH includes N IRB resources, the N IRB resources are continuous IRB resources, where N is a positive integer greater than 1.

Exemplary, the SCI includes a first information field for determining an IRB index and/or a number of IRBs in the transmission resource carrying the PSSCH.

The IRB index is used for determining a frequency domain starting position of the transmission resource carrying the PSSCH.

The number of IRBs is used for determining a frequency domain resource size of the transmission resource carrying the PSSCH.

In a different embodiment, the first terminal generates an SCI, and the first terminal transmits the SCI to the second terminal. The SCI is used for scheduling transmission resources for K PSSCHs, where K is a positive integer. Exemplary, K=1, or K=2, or K=3.

### First Example: SCI Indicating a Transmission Resource for One PSSCH (a First PSSCH)

The first terminal transmits an SCI to the second terminal, the SCI carries a first information field, the first information field carries a first value, and the first value is determined based on the number of IRBs included in the transmission resource for the one PSSCH.

Exemplary, the first value is represented by a frequency resource indicator value (FRIV),

$$FRIV = {L}_{IRB} ;$$

where the L_{IRB} indicates the number of IRBs included in the transmission resource for one PSSCH.

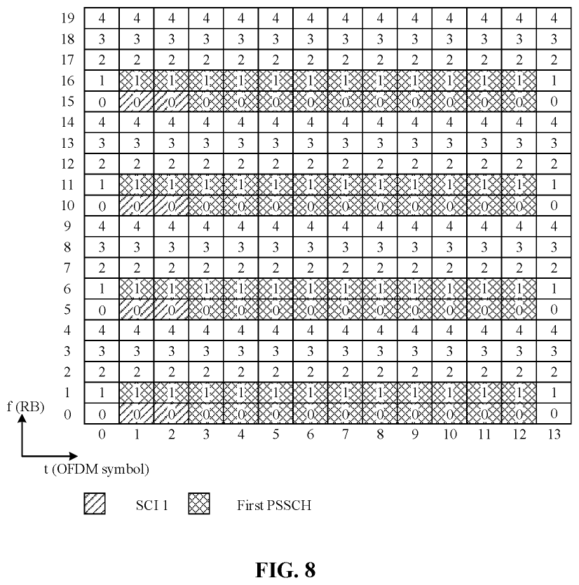

As shown in FIG. 8, the first terminal transmits SCI 1 on a transmission resource for carrying PSCCH, which occupies 2 symbols in the time domain and 4 RBs with IRB index=IRB #0 in the frequency domain. The SCI 1 indicates the transmission resource for one PSSCH. The transmission resource for one PSSCH occupies 1 slot in the time domain, occupies 4 RBs with IRB index=IRB #0 and 4 RBs with IRB index=IRB #1 in the frequency domain, and IRB #0 and IRB #1 are continuous IRBs.

The SCI 1 carries the FRIV, and the FRIV=L_{IRB}=2. As can be seen from FIG. 8, the frequency domain starting position of the transmission resource for carrying the SCI 1 is IRB #0, and the frequency domain starting position of the transmission resource for carrying the first PSSCH is also IRB #0.

### Second Example: SCI Indicating Transmission Resources for Two PSSCHs (the First PSSCH and a Second PSSCH)

The first terminal transmits an SCI to the second terminal, and the SCI indicates the transmission resources for two PSSCHs. The transmission resources include a first transmission resource and a second transmission resource. Exemplary, the first transmission resource and the second transmission resource include a same number of IRBs, but at different positions in the time domain. For example, the first transmission resource is used for the first PSSCH in this transmission, and the second transmission resource is reserved for the second PSSCH for use. The first transmission resource and the second transmission resource are located in different slots.

The first information field carries a first value determined based on the number of IRBs included in the first transmission resource or the second transmission resource and an IRB index of the second transmission resource.

Exemplary, the first value is represented by an FRIV,

$$FRIV = {n}_{IRB , 1}^{start} + {\sum }_{i = 1}^{{L}_{IRB} - 1} ( {N}_{IRB}^{SL} + 1 - i ) ;$$

where the L_{IRB} indicates the number of IRBs included in the first transmission resource or the second transmission resource, n_{IRB,1}^{start} indicates the IRB index corresponding to the frequency domain starting position of the second transmission resource, and N_{IRB}^{SL} indicates a number of IRBs included in the resource pool.

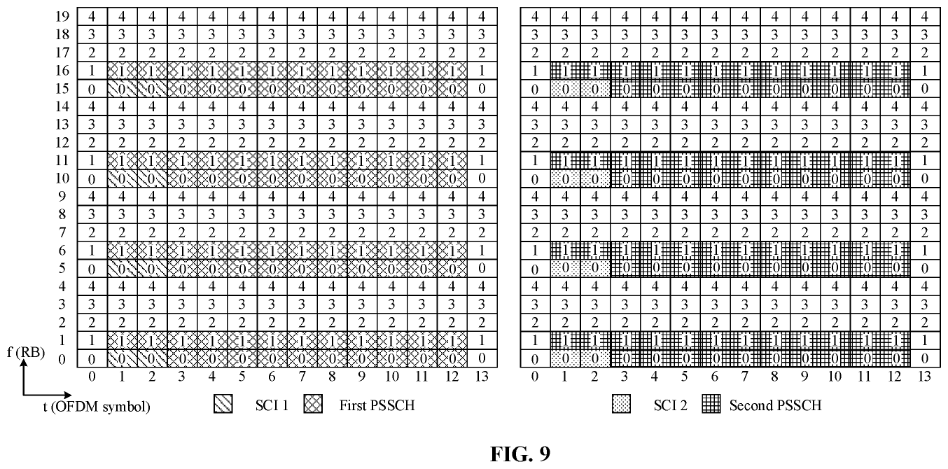

As shown in FIG. 9, the first terminal transmits SCI 1 and SCI 2 on the transmission resource for carrying the PSCCH, SCI 1 is located in a slot n and SCI 2 is located in a slot n+k1. The transmission resource carrying the PSCCH occupies 2 symbols in the time domain and 4 RBs with IRB index=IRB #0 in the frequency domain. The SCI 1 indicates the transmission resources for two PSSCHs, i.e., the transmission resources for the PSSCHs in the slot n and the slot n+k1 in the figure. The transmission resource for each PSSCH occupies 1 slot in the time domain, occupies 4 RBs with IRB index=IRB #0 and 4 RBs with IRB index=IRB #1 in the frequency domain, and IRB #0 and IRB #1 are continuous IRBs. The SCI 2 indicates the transmission resource for one PSSCH, i.e., the transmission resource for the PSSCH in the slot n+k1 in the figure.

Due to n_{IRB,1}^{start}=0, L_{IRB}=2, N_{IRB}^{SL}=4, so SCI 1 carries the FRIV, and the FRIV=0+(4+1−1)=4. SCI 2 carries the FRIV, and the FRIV=L_{IRB}=2.

It should be understood that in this embodiment, the frequency domain starting positions of the transmission resources for two PSSCHs may be different.

### Third Example: SCI Indicating Transmission Resources for Three PSSCHs (the First PSSCH, the Second PSSCH, and a Third PSSCH)

The first terminal transmits an SCI to the second terminal, and the SCI indicates the transmission resources for three PSSCHs. The transmission resources include a first transmission resource, a second transmission resource and a third transmission resource. Exemplary, the first transmission resource, the second transmission resource and the third transmission resource include a same number of IRBs, but at different positions in the time domain. For example, the first transmission resource is used for the PSSCH in this transmission, and the second transmission resource and the third transmission resource are reserved for the PSSCHs for use. The first transmission resource, the second transmission resource and the third transmission resource are located in different slots.

The first information field carries a first value determined based on the number of IRBs included in the first transmission resource or the second transmission resource or the third transmission resource, an IRB index of the second transmission resource, and an IRB index of the third transmission resource.

Exemplary, the first value is represented by an FRIV,

$$FRIV = {n}_{IRB , 1}^{start} + {n}_{IRB , 2}^{start} \cdot ( {N}_{IRB}^{SL} + 1 - {L}_{IRB} ) + {\sum }_{i = 1}^{{L}_{IRB} - 1} {( {N}_{IRB}^{SL} + 1 - i )}^{2} ;$$

where the L_{IRB} indicates the number of IRBs included in the first transmission resource or the second transmission resource or the third transmission resource, n_{IRB,1}^{start} indicates the IRB index corresponding to the frequency domain starting position of the second transmission resource, n_{IRB,2}^{start} indicates the IRB index corresponding to the frequency domain starting position of the third transmission resource, and N_{IRB}^{SL} indicates a number of IRBs included in a resource pool.

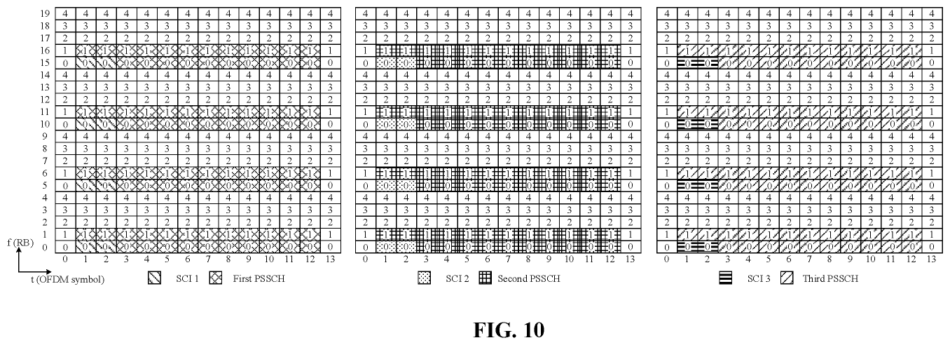

As shown in FIG. 10, the first terminal transmit SCI 1, SCI 2 and SCI 3 on the transmission resource for carrying the PSCCH, where SCI1 is located in a slot n, SCI2 is located in a slot n+k1, and SCI3 is located in a slot n+k2. The transmission resource carrying the PSCCH occupies 2 symbols in the time domain and 4 RBs with IRB index=IRB #0 in the frequency domain. The SCI 1 indicates the transmission resources for three PSSCHs, i.e. the transmission resources for the PSSCHs in the slot n, the slot n+k1 and the slot n+k2 in the figure. The transmission resource for each PSSCH occupies 1 slot in the time domain, occupies 4 RBs with IRB index=IRB #0 and 4 RBs with IRB index=IRB #1 in the frequency domain, and IRB #0 and IRB #1 are continuous IRBs. The SCI 2 indicates the transmission resources for two PSSCHs, i.e., the transmission resources for the PSSCHs in the slot n+k1 and the slot n+k2 in the figure. The SCI 3 indicates the transmission resource for one PSSCH, i.e., the transmission resource for the PSSCH in the slot n+k2 in the figure.

Due to n_{IRB,1}^{start}=0, n_{IRB,2}^{start}=0, L_{IRB}=2, N_{IRB}^{SL}=4, so SCI 1 carries the FRIV, and the FRIV=0+0·(4+1−2)+(4+1−1)²=16. SCI 2 carries the FRIV, and the FRIV=4. SCI 3 carries the FRIV, and the FRIV=2.

It should be understood that in this embodiment, the frequency domain starting positions of the transmission resources for three PSSCHs may be different.

In summary, with the method provided in the embodiment, in a scenario where the SL-U uses a transmission resource in an IRB format, the SCI is transmitted from the first terminal to the second terminal, the transmission resource for the PSSCH can be indicated using the SCI, and the transmission resource is based on the IRB. Therefore, SL-U can support for sidelink transmission, especially when using the transmission resource in the IRB format.

The method provided in the embodiment may accurately indicate the transmission resources for 1 to 3 PSSCHs by using the first information field to indicate the IRB index and/or the number of IRBs. Therefore, in case that SL-U uses the resource granularity format of IRB, the requirement of resource reservation mechanism in the related art is met, and for example, resource reservation between two TBs is supported.

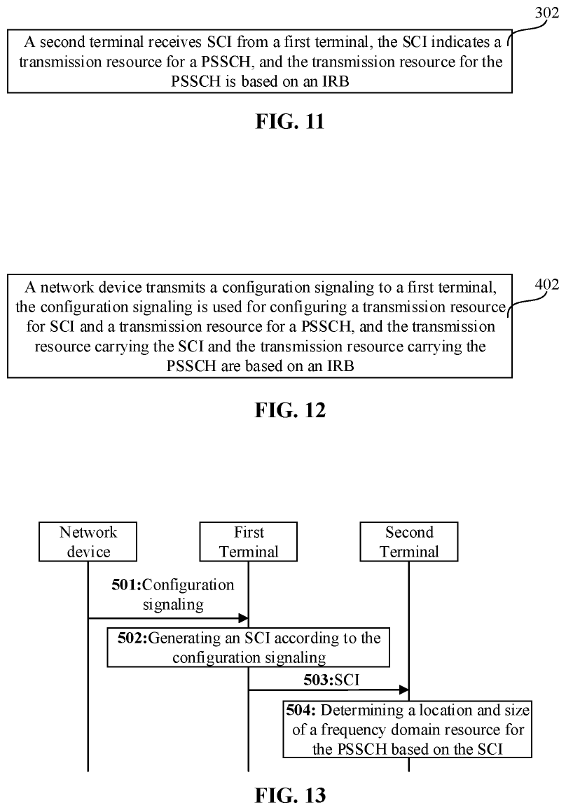

FIG. 11 illustrates a flowchart of a method for indicating sidelink transmission resource provided by an exemplary embodiment of the disclosure. This embodiment is exemplified by applying this method to at least two terminals shown in FIG. 6. The method includes the following operation.

At operation 302, a second terminal receives SCI from a first terminal. The SCI indicates a transmission resource for a PSSCH, and the transmission resource for the PSSCH is based on an IRB.

In Mode 1, the transmission resource carrying the SCI and the transmission resource carrying the PSSCH are both indicated to the first terminal by a network device. In Mode 2, the transmission resource carrying the SCI and the transmission resource carrying the PSSCH are independently selected by the first terminal in a resource pool. These transmission resources are also referred to as “sidelink transmission resources”.

Exemplary, a frequency domain starting resource corresponding to the transmission resource carrying the SCI is the same as a frequency domain starting resource corresponding to the transmission resource carrying the PSSCH.

Exemplary, if the transmission resource carrying the PSSCH includes N IRB resources, the N IRB resources are continuous IRB resources, where N is a positive integer greater than 1.

Exemplary, the SCI includes a first information field for determining an IRB index and/or a number of IRBs in the transmission resource carrying the PSSCH.

The IRB index is used for determining a frequency domain starting position of the transmission resource carrying the PSSCH.

The number of IRBs is used for determining a frequency domain resource size of the transmission resource carrying the PSSCH.

In a different embodiment, the second terminal receives an SCI from the first terminal, and the SCI is used for scheduling K sidelink transmission resources, where K is a positive integer. Exemplary, K=1, or K=2, or K=3. In case of scheduling a different number of sidelink transmission resources, a specific form of the first information field carried by the SCI may refer to the method embodiment shown in FIG. 7 and will not be described in detail.

In summary, with the method provided in the embodiment, in a scenario where the NR-U uses a transmission resource in an IRB format, the SCI is transmitted from the first terminal to the second terminal, the transmission resource for the PSSCH may be indicated using the SCI, and the transmission resource is based on the IRB. Therefore, the NR-U can support for sidelink transmission, especially when using the transmission resource in the IRB format.

The method provided in the embodiment may accurately indicate the transmission resources for 1 to 3 PSSCHs by using the first information field to indicate the IRB index and/or the number of IRBs. Therefore, in case that NR-U uses the resource granularity format of IRB, the requirement of resource reservation mechanism in the related art is met, and for example, resource reservation between two TBs is supported.

FIG. 12 illustrates a flowchart of a method for indicating sidelink transmission resource provided by an exemplary embodiment of the disclosure. This embodiment is exemplified by applying this method to at least two terminals shown in FIG. 6. The method includes the following operation.

At operation 402, a network device transmits a configuration signaling to a first terminal, the configuration signaling is used for configuring a transmission resource for SCI and a transmission resource for a PSSCH, and the transmission resource carrying the SCI and the transmission resource carrying the PSSCH are based on an IRB.

In Mode 1, the transmission resources carrying the SCI and the transmission resources carrying the PSSCH are both configured or indicated to the first terminal by the network device. These transmission resources are also referred to as “sidelink transmission resources”.

Schematically, the configuration signaling includes first indication information, and the first indication information includes an IRB index for determining a frequency domain starting position of the transmission resource carrying the SCI. A frequency domain starting resource corresponding to the transmission resource carrying the SCI is the same as a frequency domain starting resource corresponding to the transmission resource carrying the PSSCH.

Schematically, the configuration signaling includes second indication information for determining a first information field, and the first information field is used for determining an IRB index and/or a number of IRBs in the transmission resource carrying the PSSCH. The IRB index is used for determining a frequency domain starting position of the transmission resource carrying the PSSCH, and the number of IRBs is used for determining a frequency domain resource size of the transmission resource carrying the PSSCH.

The second indication information is represented by the FRIV described above. If the transmission resource carrying the PSSCH includes N IRB resources, the N IRB resources are continuous IRB resources, where N is a positive integer greater than 1.

The first indication information and the second indication information may be carried in the same configuration signaling or in different configuration signaling. For example, the first indication information is carried in the first configuration signaling, and the second indication information is carried in the second configuration signaling, which is not limited in the embodiment.

Schematically, the configuration signaling includes downlink control information (DCI) signaling or a radio resource control (RRC) signaling. In case of scheduling different numbers of sidelink transmission resources, the specific form of the first information field carried by the DCI signaling or the RRC signaling may refer to the method embodiment shown in FIG. 7 and will not be described in detail.

### First Example: SCI Indicating a Transmission Resource for One PSSCH (a First PSSCH)

The first terminal transmits an SCI to the second terminal, the SCI carries a first information field and the first information field carries a first value. The first value is determined based on a number of IRBs included in the transmission resource for the one PSSCH.

Exemplary, the first value is represented by an FRIV,

$$FRIV = {L}_{IRB} ;$$

where the L_{IRB} indicates the number of IRBs included in the transmission resource for one PSSCH.

### Second Example: SCI Indicating Transmission Resources for Two PSSCHs (the First PSSCH and a Second PSSCH)

The first terminal transmits an SCI to the second terminal, and the SCI indicates the transmission resources for two PSSCHs. The transmission resources include a first transmission resource and a second transmission resource. Exemplary, the first transmission resource and the second transmission resource include a same number of IRBs, but at different positions in the time domain. For example, the first transmission resource is used for the PSSCH in this transmission, and the second transmission resource is reserved for the PSSCH for use. The first transmission resource and the second transmission resource are located in different slots.

The first information field carries a first value determined based on a number of IRBs included in the first transmission resource or the second transmission resource and an IRB index of the second transmission resource.

Exemplary, the first value is represented by an FRIV,

$$FRIV = {n}_{IRB , 1}^{start} + {\sum }_{i = 1}^{{L}_{IRB} - 1} ( {N}_{IRB}^{SL} + 1 - i ) ;$$

where the L_{IRB} indicates the number of IRBs included in the first transmission resource or the second transmission resource, n_{IRB,1}^{start} indicates the IRB index corresponding to the frequency domain starting position of the second transmission resource, and N_{IRB}^{SL} indicates a number of IRBs included in a resource pool. The IRB index of the second transmission resource is used for determining the frequency domain starting position of the second transmission resource.

### Third Example: SCI Indicating Transmission Resources for Three PSSCHs (the First PSSCH, the Second PSSCH, and a Third PSSCH)

The first terminal transmits an SCI to the second terminal, and the SCI indicates the transmission resources for three PSSCHs. The transmission resources include a first transmission resource, a second transmission resource and a third transmission resource. Exemplary, the first transmission resource, the second transmission resource and the third transmission resource include a same number of IRBs, but at different positions in the time domain. For example, the first transmission resource is used for the PSSCH in this transmission, and the second transmission resource and the third transmission resource are reserved for the PSSCHs for use. The first transmission resource, the second transmission resource and the third transmission resource are located in different slots.

The first information field carries a first value determined based on a number of IRBs included in the first transmission resource or the second transmission resource or the third transmission resource, an IRB index of the second transmission resource, and an IRB index of the third transmission resource. The IRB index of the second transmission resource is used for determining the frequency domain starting position of the second transmission resource, and the IRB index of the third transmission resource is used for determining a frequency domain starting position of the third transmission resource.

Exemplary, the first value is represented by an FRIV,

$$FRIV = {n}_{IRB , 1}^{start} + {n}_{IRB , 2}^{start} \cdot ( {N}_{IRB}^{SL} + 1 - {L}_{IRB} ) + {\sum }_{i = 1}^{{L}_{IRB} - 1} {( {N}_{IRB}^{SL} + 1 - i )}^{2} ;$$

where the L_{IRB} indicates the number of IRBs included in the first transmission resource or the second transmission resource or the third transmission resource, n_{IRB,1}^{start} indicates the IRB index corresponding to the frequency domain starting position of the second transmission resource, n_{IRB,2}^{start} indicates the IRB index corresponding to the frequency domain starting position of the third transmission resource, and N_{IRB}^{SL} indicates a number of IRBs included in a resource pool.

In summary, with the method provided in the embodiment, in a scenario where the NR-U uses a transmission resource in an IRB format, the configuration signaling is transmitted to the first terminal by the network device, so that the NR-U can support for sidelink transmission for Mode 1, especially when using the transmission resource in the IRB format.

### Sidelink Transmission for Mode 1

FIG. 13 illustrates a flowchart of a sidelink transmission method provided by an exemplary embodiment of the disclosure. The method includes the following operations.

At operation 501, a network device transmits a configuration signaling to a first terminal, the configuration signaling is used for configuring a transmission resource for SCI and a transmission resource for a PSSCH, and the transmission resource carrying the SCI and the transmission resource carrying the PSSCH are based on an IRB.

The specific implementation may refer to operation 402.

Accordingly, the first terminal receives the configuration signaling from the network side (or the network device).

At operation 502, the first terminal generates the SCI based on the configuration signaling.

The first terminal determines a frequency domain starting position of the transmission resource carrying the SCI based on first indication information in the configuration signaling.

The first terminal determines a first information field based on second indication information in the configuration signaling, and generates the SCI carrying the first information field. For example, the first information field includes a first value, and a calculation formula for the first value is shown in the embodiment with reference to FIG. 7.

Exemplary, the second indication information includes an FRIV. When the configuration signaling is used for configuring one sidelink transmission resource, the first terminal determines a number of IRBs occupied by the sidelink transmission resource based on the FRIV. When the configuration signaling is used for configuring two sidelink transmission resources, frequency domain resource sizes of the two sidelink transmission resources are the same, and the first terminal determines the number of IRBs occupied by each of the sidelink transmission resources and an IRB index corresponding to a frequency domain starting position of a second sidelink transmission resource based on the FRIV. When the configuration signaling is used for configuring three sidelink transmission resources, the frequency domain resource sizes of the three sidelink transmission resources are the same, and the first terminal determines the number of IRBs occupied by each of the sidelink transmission resources, the IRB index corresponding to the frequency domain starting position of the second sidelink transmission resource and an IRB index corresponding to a frequency domain starting position of a third sidelink transmission resource based on the FRIV.

Exemplary, the operation that the first terminal determines the first information field based on the second indication information in the configuration signaling and generates the SCI carrying the first information field includes the following actions.

The configuration signaling is used for configuring one sidelink transmission resource, the second indication information in the configuration signaling includes an FRIV, and the first terminal takes the FRIV as the value of the FRIV included in the first information field.

That is, FRIV=L_{IRB};
where the L_{IRB} indicates the number of IRBs included in the transmission resource for one PSSCH.

The configuration signaling is used for configuring two sidelink transmission resources, and the second indication information in the configuration signaling includes an FRIV.

The first terminal determines the number of IRBs occupied by each of the sidelink transmission resources and the IRB index corresponding to the frequency domain starting position of the second sidelink transmission resource based on the FRIV.

When the first terminal transmits the SCI in the first sidelink transmission resource, the first terminal takes the FRIV included in the second indication information in the configuration signaling as the value of the FRIV included in the first information field.

That is, FRIV=n_{IRB,1}^{start}+Σᵢ₌₁^{L}^{_{IRB}}⁻¹(N_{IRB}^{SL}+1−i);
where the L_{IRB} indicates the number of IRBs included in the first transmission resource or the second transmission resource, n_{IRB,1}^{start} indicates the IRB index corresponding to the frequency domain starting position of the second transmission resource, and N_{IRB}^{SL} indicates a number of IRBs included in a resource pool. The IRB index of the second transmission resource is used for determining the frequency domain starting position of the second transmission resource.

When the first terminal transmits the SCI in the second sidelink transmission resource, the first terminal determines the value of the FRIV included in the first information field based on the number of IRBs occupied by the sidelink transmission resource, for example, sets the value of the FRIV as the number of IRBs occupied by the sidelink transmission resource.

That is, the FRIV=L_{IRB}.

The configuration signaling is used for configuring three sidelink transmission resources, and the second indication information in the configuration signaling includes an FRIV.

The first terminal determines the number of IRBs occupied by each of the sidelink transmission resources, the IRB index corresponding to the frequency domain starting position of the second sidelink transmission resource and the IRB index corresponding to the frequency domain starting position of the third sidelink transmission resource based on the FRIV.

When the first terminal transmits the SCI in the first sidelink transmission resource, the first terminal takes the FRIV as the value of the FRIV included in the first information field. The FRIV is as follows.

$$FRIV = {n}_{IRB , 1}^{start} + {n}_{IRB , 2}^{start} \cdot ( {N}_{IRB}^{SL} + 1 - {L}_{IRB} ) + {\sum }_{i = 1}^{{L}_{IRB} - 1} {( {N}_{IRB}^{SL} + 1 - i )}^{2} ;$$

where the L_{IRB} indicates the number of IRBs included in the first transmission resource or the second transmission resource or the third transmission resource, n_{IRB,1}^{start} indicates the IRB index corresponding to the frequency domain starting position of the second transmission resource, n_{IRB,2}^{start} indicates the IRB index corresponding to the frequency domain starting position of the third transmission resource, and N_{IRB}^{SL} indicates a number of IRBs included in a resource pool.

When the first terminal transmits the SCI in the second sidelink transmission resource, the first terminal determines the value of the FRIV included in the first information field based on the number of IRBs occupied by the sidelink transmission resource and the IRB index corresponding to the frequency domain starting position of the third sidelink transmission resource.

For example, FRIV=n_{IRB,2}^{start}+Σᵢ₌₁^{L}^{_{IRB}}⁻¹(N_{IRB}^{SL}+1−i);
where the L_{IRB} indicates the number of IRBs included in the sidelink transmission resource, n_{IRB,2}^{start} indicates the IRB index corresponding to the frequency domain starting position of the third sidelink transmission resource, and N_{IRB}^{SL} indicates the number of IRBs included in the resource pool.

When the first terminal transmits the SCI in the third sidelink transmission resource, the first terminal determines the value of FRIV included in the first information field based on the number of IRBs occupied by the sidelink transmission resource, for example, sets the value of FRIV as the number of IRBs occupied by the sidelink transmission resource. That is, the FRIV=L_{IRB}.

At operation 503, the first terminal transmits the SCI to a second terminal.

Accordingly, the second terminal receives the SCI.

At operation 504, the second terminal determines positions and number of frequency domain resources for the PSSCH based on the SCI.

Since the frequency domain starting resource corresponding to the transmission resource carrying the SCI is the same as the frequency domain starting resource corresponding to the transmission resource carrying the PSSCH, and the transmission resource carrying the SCI and the first transmission resource carrying the PSSCH are located in the same slot, the second terminal may determine the frequency domain starting resource corresponding to the first transmission resource carrying the PSSCH based on the frequency domain starting resource corresponding to the transmission resource carrying the SCI.

The second terminal extracts the first information field from the SCI. The IRB index and/or the number of IRBs in the transmission resource carrying the PSSCH are determined based on the first value in the first information field. The IRB index is used for determining the frequency domain starting position of the second transmission resource and/or the third transmission resource indicated by the SCI. The number of IRBs is used for determining the frequency domain resource size (the number of IRBs) of the transmission resource carrying the PSSCH.

Referring to the embodiment shown in FIG. 7, a unique FRIV may be determined based on the number of IRBs included in the transmission resource and/or the IRB index corresponding to the frequency domain starting position of the transmission resource, and the second terminal may derive the number of IRBs included in the transmission resource and/or the IRB index corresponding to the frequency domain starting position of the transmission resource based on the FRIV carried in the SCI and the above formula (the number of IRBs and the IRB index corresponding to the FRIV), thereby accurately determining the positions and number of the frequency domain resources for each PSSCH.

Sidelink transmission for Mode 2

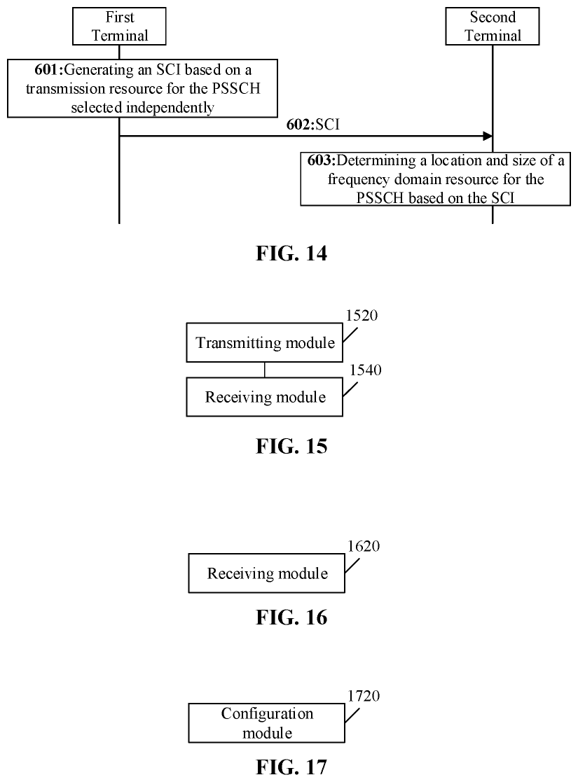

FIG. 14 illustrates a flowchart of a sidelink transmission method provided by an exemplary embodiment of the disclosure. The method includes the following operations.

At operation 601, a first terminal generates an SCI based on a transmission resource for PSSCH selected independently.

The first terminal independently selects K transmission resources for carrying the PSSCH in a resource pool, for example, K=1, or K=2, or K=3. The first terminal generates an SCI based on the transmission resource for the PSSCH selected independently.

The first terminal determines a frequency domain starting position of a transmission resource carrying the SCI based on a frequency domain starting resource corresponding to a first transmission resource carrying the PSSCH.

The first terminal determines a first information field based on an IRB index and/or the number of IRBs in the transmission resource carrying the PSSCH, and generates the SCI carrying the first information field. Taking the first information field including a first value as an example, the calculation formula for the first value is shown in the embodiment of FIG. 7.

Exemplary, the operation that the first terminal determines the first information field based on the transmission resource for the PSSCH selected independently and generates the SCI carrying the first information field includes the following actions.

When one sidelink transmission resource is selected independently, FRIV is determined based on the number of IRBs occupied by the sidelink transmission resource, and the first terminal takes the FRIV as a value of FRIV included in the first information field.

That is, FRIV=L_{IRB};
where the L_{IRB} indicates the number of IRBs included in the transmission resource for one PSSCH.

When two sidelink transmission resources are selected independently:
in response to transmitting the SCI in a first sidelink transmission resource, the first terminal determines the FRIV based on the number of IRBs occupied by the sidelink transmission resource and an IRB index corresponding to a frequency domain starting position of a second sidelink transmission resource, and the first terminal takes the FRIV as the value of the FRIV included in the first information field.

That is, FRIV=n_{IRB,1}^{start}+Σᵢ₌₁^{L}^{_{IRB}}⁻¹(N_{IRB}^{SL}+1−i);
where the L_{IRB} indicates the number of IRBs included in the first transmission resource or the second transmission resource, n_{IRB,1}^{start} indicates the IRB index corresponding to the frequency domain starting position of the second transmission resource, and N_{IRB}^{SL} indicates a number of IRBs included in the resource pool. The IRB index of the second transmission resource is used for determining the frequency domain starting position of the second transmission resource.

In response to transmitting the SCI in the second sidelink transmission resource, the first terminal determines the FRIV based on the number of IRBs occupied by the sidelink transmission resource, and the first terminal takes the FRIV as the value of the FRIV included in the first information field.

That is, FRIV=L_{IRB};
where the L_{IRB} indicates the number of IRBs included in the transmission resource for one PSSCH.

When three sidelink transmission resources are selected independently:
in response to transmitting the SCI in a first sidelink transmission resource, the first terminal determines the FRIV based on the number of IRBs occupied by the sidelink transmission resource, an IRB index corresponding to a frequency domain starting position of a second sidelink transmission resource and an IRB index corresponding to a frequency domain starting position of a third sidelink transmission resource, and the first terminal takes the FRIV as the value of the FRIV included in the first information field.

That is, FRIV=n_{IRB,1}^{start}+n_{IRB,2}^{start}·(N_{IRB}^{SL}+1−L_{IRB})=Σᵢ₌₁^{L}^{_{IRB}}⁻¹(N_{IRB}^{SL}+1−i)²;
where the L_{IRB} indicates the number of IRBs included in the first transmission resource or the second transmission resource or the third transmission resource, n_{IRB,1}^{start} indicates the IRB index corresponding to the frequency domain starting position of the second transmission resource, n_{IRB,2}^{start} indicates the IRB index corresponding to the frequency domain starting position of the third transmission resource, and N_{IRB}^{SL} indicates a number of IRBs included in the resource pool.

In response to transmitting the SCI in the second sidelink transmission resource, the first terminal determines the FRIV based on the number of IRBs occupied by the sidelink transmission resource and the IRB index corresponding to the frequency domain starting position of the third sidelink transmission resource, and the first terminal takes the FRIV as the value of the FRIV included in the first information field.

That is, FRIV=n_{IRB,2}^{start}+Σᵢ₌₁^{L}^{_{IRB}}⁻¹(N_{IRB}^{SL}+1−i);
where the L_{IRB} indicates the number of IRBs included in the sidelink transmission resources, n_{IRB,2}^{start} indicates the IRB index corresponding to the frequency domain starting position of the third sidelink transmission resource, and N_{IRB}^{SL} indicates a number of IRBs included in the resource pool.

In response to transmitting the SCI in the third sidelink transmission resource, the first terminal determines the FRIV based on the number of IRBs occupied by the sidelink transmission resource, and the first terminal takes the FRIV as the value of the FRIV included in the first information field.

That is, FRIV=L_{IRB};
where the L_{IRB} indicates the number of IRBs included in the transmission resource for one PSSCH.

At operation 602, the first terminal transmits the SCI to a second terminal.

Accordingly, the second terminal receives the SCI.

At operation 603, the second terminal determines positions and number of frequency domain resources for the PSSCH based on the SCI.

Since the frequency domain starting resource corresponding to the transmission resource carrying the SCI is the same as the frequency domain starting resource corresponding to the transmission resource carrying the PSSCH, and the transmission resource carrying the SCI and the first transmission resource carrying the PSSCH are located in the same slot, the second terminal may determine the frequency domain starting resource corresponding to the first transmission resource carrying the PSSCH based on the frequency domain starting resource corresponding to the transmission resource carrying the SCI.

The second terminal extracts the first information field from the SC. The IRB index and/or the number of IRBs in the transmission resource carrying the PSSCH are determined based on the first value in the first information field. The IRB index is used for determining the frequency domain starting positions of the second transmission resource and/or the third transmission resource carrying the PSSCH. The number of IRBs is used for determining the frequency domain resource size (the number of IRBs) of the transmission resource carrying the PSSCH.

Referring to the embodiment shown in FIG. 7, a unique FRIV may be determined based on the number of IRBs included in the transmission resource and/or the IRB index corresponding to the frequency domain starting position of the transmission resource, and the second terminal may derive the number of IRBs included in the transmission resource and/or the IRB index corresponding to the frequency domain starting position of the transmission resource based on the FRIV carried in the SCI and the above formula (the number of IRBs and the IRB index corresponding to the FRIV), thereby accurately determining the positions and number of the frequency domain resources for each PSSCH.

FIG. 15 illustrates a block diagram of an apparatus for indicating sidelink transmission resource provided by an exemplary embodiment of the disclosure. The apparatus may be implemented as a first terminal or a functional module within the first terminal, and the apparatus includes a transmitting module 1520.

The transmitting module 1520 is configured to transmit SCI to a second terminal, and the SCI indicates a transmission resource for a PSSCH. The transmission resource for the PSSCH is based on an IRB.

In an optional design, a frequency domain starting resource corresponding to a transmission resource carrying the SCI is the same as a frequency domain starting resource corresponding to the transmission resource carrying the PSSCH.

In an optional design, if the transmission resource carrying the PSSCH includes N IRB resources, the N IRB resources are continuous IRB resources, and N is a positive integer greater than 1.

In an optional design, the SCI includes a first information field for determining an IRB index and/or a number of IRBs in the transmission resource carrying the PSSCH.

The IRB index is used for determining a frequency domain starting position of the transmission resource carrying the PSSCH.

The number of IRBs is used for determining a frequency domain resource size of the transmission resource carrying the PSSCH.

In an optional design, the SCI indicates a transmission resource for one PSSCH.

The first information field carries a first value determined based on the number of IRBs included in the transmission resource for the one PSSCH.

In an optional design, the first value is represented by an FRIV,

$$FRIV = {L}_{IRB} ;$$

where the L_{IRB} indicates the number of IRBs included in the transmission resource for the one PSSCH.

In an optional design, the SCI indicates transmission resources for two PSSCHs, and the transmission resources include a first transmission resource and a second transmission resource.

The first transmission resource and the second transmission resource include a same number of IRBs.

The first information field carries a first value determined based on the number of IRBs included in the first transmission resource or the second transmission resource and an IRB index of the second transmission resource. The IRB index of the second transmission resource is used for determining a frequency domain starting position of the second transmission resource.

In an optional design, the first value is represented by an FRIV,

$$FRIV = {n}_{IRB , 1}^{start} + {\sum }_{i = 1}^{{L}_{IRB} - 1} ( {N}_{IRB}^{SL} + 1 - i ) ;$$

where the L_{IRB} indicates the number of IRBs included in the first transmission resource or the second transmission resource, n_{IRB,1}^{start} indicates the IRB index corresponding to the frequency domain starting position of the second transmission resource, and N_{IRB}^{SL} indicates a number of IRBs included in a resource pool.

In an optional design, the SCI indicates transmission resources for three PSSCHs, and the transmission resources include a first transmission resource, a second transmission resource, and a third transmission resource.

The first transmission resource, the second transmission resource and the third transmission resource include a same number of IRBs.

The first information field carries a first value determined based on the number of IRBs included in the first transmission resource or the second transmission resource or the third transmission resource, an IRB index of the second transmission resource, and an IRB index of the third transmission resource. The IRB index of the second transmission resource is used for determining a frequency domain starting position of the second transmission resource, and the IRB index of the third transmission resource is used for determining a frequency domain starting position of the third transmission resource.

In an optional design, the first value is represented by an FRIV,

$$FRIV = {n}_{IRB , 1}^{start} + {n}_{IRB , 2}^{start} \cdot ( {N}_{IRB}^{SL} + 1 - {L}_{IRB} ) + {\sum }_{i = 1}^{{L}_{IRB} - 1} {( {N}_{IRB}^{SL} + 1 - i )}^{2} ;$$

where the L_{IRB} indicates the number of IRBs included in the first transmission resource or the second transmission resource or the third transmission resource, n_{IRB,1}^{start} indicates the IRB index corresponding to the frequency domain starting position of the second transmission resource, n_{IRB,2}^{start} indicates the IRB index corresponding to the frequency domain starting position of the third transmission resource, and N_{IRB}^{SL} indicates a number of IRBs included in a resource pool.

In an optional design, the apparatus further includes a receiving module 1540.

The receiving module 1540 is configured to receive a configuration signaling from a network side. The configuration signaling is used for configuring a transmission resource for the SCI and the transmission resource for the PSSCH. The transmission resource carrying the SCI and the transmission resource carrying the PSSCH are based on the IRB.

In an optional design, the configuration signaling includes first indication information, and the first indication information includes an IRB index for determining a frequency domain starting position of the transmission resource carrying the SCI.

In an optional design, the configuration signaling includes second indication information for determining the first information field.

In an optional design, the configuration signaling includes DCI signaling or an RRC signaling.

FIG. 16 illustrates a block diagram of an apparatus for indicating sidelink transmission resource provided by an exemplary embodiment of the disclosure. The apparatus may be implemented as a second terminal or a functional module within the second terminal, and the apparatus includes a receiving module 1620.

The receiving module 1620 is configured to receive SCI from a first terminal. The SCI indicates a transmission resource for a PSSCH, and the transmission resource for the PSSCH is based on an IRB.

In an optional design, a frequency domain starting resource corresponding to a transmission resource carrying the SCI is the same as a frequency domain starting resource corresponding to the transmission resource carrying the PSSCH.

In an optional design, if the transmission resource carrying the PSSCH includes N IRB resources, the N IRB resources are continuous IRB resources, and N is a positive integer greater than 1.

In an optional design, the SCI includes a first information field for determining an IRB index and/or a number of IRBs in the transmission resource carrying the PSSCH.

The IRB index is used for determining a frequency domain starting position of the transmission resource carrying the PSSCH.

The number of IRBs is used for determining a frequency domain resource size of the transmission resource carrying the PSSCH.

In an optional design, the SCI indicates a transmission resource for one PSSCH.

The first information field carries a first value determined based on the number of IRBs included in the transmission resource for the one PSSCH.

In an optional design, the first value is represented by an FRIV,

$$FRIV = {L}_{IRB} ;$$

where the L_{IRB} indicates the number of IRBs included in the transmission resource for the one PSSCH.

In an optional design, the SCI indicates transmission resources for two PSSCHs, and the transmission resources include a first transmission resource and a second transmission resource.

The first transmission resource and the second transmission resource include a same number of IRBs.

The first information field carries a first value determined based on the number of IRBs included in the first transmission resource or the second transmission resource and an IRB index of the second transmission resource. The IRB index of the second transmission resource is used for determining a frequency domain starting position of the second transmission resource.

In an optional design, the first value is represented by an FRIV,

$$FRIV = {n}_{IRB , 1}^{start} + {\sum }_{i = 1}^{{L}_{IRB} - 1} ( {N}_{IRB}^{SL} + 1 - i ) ;$$

where the L_{IRB} indicates the number of IRBs included in the first transmission resource or the second transmission resource, n_{IRB,1}^{start} indicates the IRB index corresponding to the frequency domain starting position of the second transmission resource, and N_{IRB}^{SL} indicates a number of IRBs included in a resource pool.

In an optional design, the SCI indicates transmission resources for three PSSCHs, and the transmission resources include a first transmission resource, a second transmission resource, and a third transmission resource.

The first transmission resource, the second transmission resource and the third transmission resource include a same number of IRBs.

The first information field carries a first value determined based on the number of IRBs included in the first transmission resource or the second transmission resource or the third transmission resource, an IRB index of the second transmission resource, and an IRB index of the third transmission resource. The IRB index of the second transmission resource is used for determining a frequency domain starting position of the second transmission resource, and the IRB index of the third transmission resource is used for determining a frequency domain starting position of the third transmission resource.

In an optional design, the first value is represented by an FRIV,

$$FRIV = {n}_{IRB , 1}^{start} + {n}_{IRB , 2}^{start} \cdot ( {N}_{IRB}^{SL} + 1 - {L}_{IRB} ) + {\sum }_{i = 1}^{{L}_{IRB} - 1} {( {N}_{IRB}^{SL} + 1 - i )}^{2} ;$$

where the L_{IRB} indicates the number of IRBs included in the first transmission resource or the second transmission resource or the third transmission resource, n_{IRB}^{start} indicates the IRB index corresponding to the frequency domain starting position of the second transmission resource, n_{IRB,2}^{start} indicates the IRB index corresponding to the frequency domain starting position of the third transmission resource, and N_{IRB}^{SL} indicates a number of IRBs included in a resource pool.

FIG. 17 illustrates a block diagram of an apparatus for indicating sidelink transmission resource provided by an exemplary embodiment of the disclosure. The apparatus may be implemented as a network device or a functional module within the network device, and the apparatus includes a configuration module 1720.

The configuration module 1720 is configured to transmit a configuration signaling to a first terminal. The configuration signaling is used for configuring a transmission resource for SCI and a transmission resource for a PSSCH, and the transmission resource carrying the SCI and the transmission resource carrying the PSSCH are based on an IRB.

In an optional design, the configuration signaling includes first indication information, and the first indication information includes an IRB index for determining a frequency domain starting position of the transmission resource carrying the SCI.

In an optional design, the configuration signaling includes second indication information for determining a first information field, and the first information field is used for determining an IRB index and/or a number of IRBs in the transmission resource carrying the PSSCH.

The IRB index is used for determining a frequency domain starting position of the transmission resource carrying the PSSCH.

The number of IRBs is used for determining a frequency domain resource size of the transmission resource carrying the PSSCH.

In an optional design, the configuration signaling includes DCI signaling or an RRC signaling.

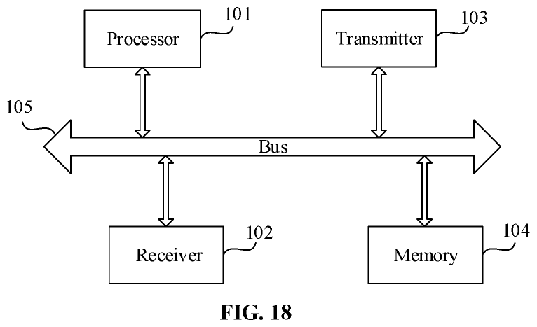

FIG. 18 illustrates a structural schematic diagram of a communication device (a first terminal or a second terminal or a network device) provided by an exemplary embodiment of the disclosure. The communication device includes: a processor 101, a receiver 102, a transmitter 103, a memory 104, and a bus 105.

The processor 101 includes one or more processing cores, and performs various functional applications and information processing by running software programs and modules.

The receiver 102 and the transmitter 103 may be implemented as a communication component, which may be a communication chip.

The memory 104 is connected to the processor 101 through the bus 105.

The memory 104 is configured to store at least one instruction, and the processor 101 is configured to execute the at least one instruction to implement the various operations in the method embodiments mentioned above.

In addition, the memory 104 may be implemented by any type of volatile or non-volatile storage device or a combination thereof. The volatile or non-volatile storage device includes, but is not limited to: a magnetic disk or an optical disk, an electrically erasable programmable read only memory (EEPROM), an erasable programmable read only memory (EPROM), a static random access memory (SRAM), a read-only memory (ROM), a magnetic memory, a flash memory, or a programmable read only memory (PROM).

In an exemplary embodiment, there is also provided a computer-readable storage medium having stored thereon at least one instruction, at least one program, a code set, or an instruction set, and the at least one instruction, the at least one program, the code set, or the instruction set is loaded and executed by the processor to implement the method for indicating sidelink transmission resource executed by a first terminal or a second terminal or a network device provided in the various method embodiments mentioned above.

In an exemplary embodiment, there is also provided a computer program product or a computer program. The computer program product or the computer program includes computer instructions stored in a computer-readable storage medium. A processor of a communication device reads the computer instructions from the computer-readable storage medium, and the processor executes the computer instructions, to enable the communication device to execute the method for indicating sidelink transmission resource executed by a first terminal or a second terminal or a network device as described above.

Technical solutions provided in the embodiments of the disclosure include at least the following beneficial effects.

In a scenario where the SL-U uses a transmission resource in an IRB format, the SCI is transmitted from the first terminal to the second terminal, the transmission resource for the PSSCH can be indicated using the SCI, and the transmission resource is based on the IRB. Therefore, SL-U can support for sidelink transmission using the transmission resource in the IRB format.

Described above are merely optional embodiments of the disclosure, and are not intended to limit the disclosure. Any modification, equivalent replacement, improvement, etc. made within the spirit and principle of the disclosure shall fall within the scope of protection of the disclosure.

1. An apparatus for indicating sidelink transmission resource, comprising:
a processor;
a transceiver connected to the processor; and
a memory for storing instructions executable by the processor;
wherein the processor is configured to load and execute the instructions to:
control the transceiver to transmit sidelink control information to a second terminal, the sidelink control information indicating a transmission resource for a physical sidelink shared channel (PSSCH), wherein the transmission resource for the PSSCH is based on an interlaced resource block (IRB).

2. The apparatus of claim 1, wherein a frequency domain starting resource corresponding to a transmission resource carrying the sidelink control information is the same as a frequency domain starting resource corresponding to the transmission resource carrying the PSSCH.

3. The apparatus of claim 1, wherein if the transmission resource carrying the PSSCH comprises N IRB resources, the N IRB resources are continuous IRB resources, N being a positive integer greater than 1.

4. The apparatus of claim 1, wherein the sidelink control information comprises a first information field for determining an IRB index and/or a number of IRBs in the transmission resource carrying the PSSCH;
the IRB index is used for determining a frequency domain starting position of the transmission resource carrying the PSSCH; and
the number of IRBs is used for determining a frequency domain resource size of the transmission resource carrying the PSSCH.

5. The apparatus of claim 4, wherein the sidelink control information indicates transmission resources for three PSSCHs, and the transmission resources comprise a first transmission resource, a second transmission resource, and a third transmission resource;
the first transmission resource, the second transmission resource and the third transmission resource comprise a same number of IRBs; and
the first information field carries a first value determined based on the number of IRBs comprised in the first transmission resource or the second transmission resource or the third transmission resource, an IRB index of the second transmission resource, and an IRB index of the third transmission resource, wherein the IRB index of the second transmission resource is used for determining a frequency domain starting position of the second transmission resource, and the IRB index of the third transmission resource is used for determining a frequency domain starting position of the third transmission resource.

6. The apparatus of claim 5, wherein the first value is represented by a frequency resource indicator value (FRIV),
$$FRIV = {n}_{IRB , 1}^{start} + {n}_{IRB , 2}^{start} \cdot ( {N}_{IRB}^{SL} + 1 - {L}_{IRB} ) + {\sum }_{i = 1}^{{L}_{IRB} - 1} {( {N}_{IRB}^{SL} + 1 - i )}^{2} ;$$
where the L_{IRB} indicates the number of IRBs comprised in the first transmission resource or the second transmission resource or the third transmission resource, n_{IRB,2}^{start} indicates the IRB index corresponding to the frequency domain starting position of the second transmission resource, n_{IRB,2}^{start} indicates the IRB index corresponding to the frequency domain starting position of the third transmission resource, and N_{IRB}^{SL} indicates a number of IRBs comprised in a resource pool.

7. The apparatus of claim 1, wherein the processor is further configured to:
control the transceiver to receive a configuration signaling from a network side, wherein the configuration signaling is used for configuring a transmission resource for the sidelink control information and the transmission resource for the PSSCH, and the transmission resource carrying the sidelink control information and the transmission resource carrying the PSSCH are based on the IRB.

8. The apparatus of claim 7, wherein the configuration signaling comprises first indication information, and the first indication information comprises an IRB index for determining a frequency domain starting position of the transmission resource carrying the sidelink control information.

9. The apparatus of claim 4, wherein the processor is further configured to:
control the transceiver to receive a configuration signaling from a network side, wherein the configuration signaling comprises second indication information for determining the first information field.

10. The apparatus of claim 7, wherein the configuration signaling comprises downlink control information (DCI) signaling or a radio resource control (RRC) signaling.

11. An apparatus for indicating sidelink transmission resource, comprising:
a processor;
a transceiver connected to the processor; and
a memory for storing instructions executable by the processor;
wherein the processor is configured to load and execute the instructions to:
control the transceiver to receive sidelink control information from a first terminal, wherein the sidelink control information indicates a transmission resource for a physical sidelink shared channel (PSSCH), and the transmission resource for the PSSCH is based on an interlaced resource block (IRB).

12. The apparatus of claim 11, wherein a frequency domain starting resource corresponding to a transmission resource carrying the sidelink control information is the same as a frequency domain starting resource corresponding to the transmission resource carrying the PSSCH.

13. The apparatus of claim 11, wherein if the transmission resource carrying the PSSCH comprises N IRB resources, the N IRB resources are continuous IRB resources, N being a positive integer greater than 1.

14. The apparatus of claim 11, wherein the sidelink control information comprises a first information field for determining an IRB index and/or a number of IRBs in the transmission resource carrying the PSSCH;
the IRB index is used for determining a frequency domain starting position of the transmission resource carrying the PSSCH; and
the number of IRBs is used for determining a frequency domain resource size of the transmission resource carrying the PSSCH.

15. The apparatus of claim 14, wherein the sidelink control information indicates transmission resources for three PSSCHs, and the transmission resources comprise a first transmission resource, a second transmission resource, and a third transmission resource;
the first transmission resource, the second transmission resource and the third transmission resource comprise a same number of IRBs; and
the first information field carries a first value determined based on the number of IRBs comprised in the first transmission resource or the second transmission resource or the third transmission resource, an IRB index of the second transmission resource, and an IRB index of the third transmission resource, wherein the IRB index of the second transmission resource is used for determining a frequency domain starting position of the second transmission resource, and the IRB index of the third transmission resource is used for determining a frequency domain starting position of the third transmission resource.

16. The apparatus of claim 15, wherein the first value is represented by a frequency resource indicator value (FRIV),
$$FRIV = {n}_{IRB , 1}^{start} + {n}_{IRB , 2}^{start} \cdot ( {N}_{IRB}^{SL} + 1 - {L}_{IRB} ) + {\sum }_{i = 1}^{{L}_{IRB} - 1} {( {N}_{IRB}^{SL} + 1 - i )}^{2} ;$$
where the L_{IRB} indicates the number of IRBs comprised in the first transmission resource or the second transmission resource or the third transmission resource, n_{IRB,1}^{start} indicates the IRB index corresponding to the frequency domain starting position of the second transmission resource, n_{IRB,2}^{start} indicates the IRB index corresponding to the frequency domain starting position of the third transmission resource, and N_{IRB}^{SL} indicates a number of IRBs comprised in a resource pool.

17. An apparatus for indicating sidelink transmission resource, comprising:
a processor;
a transceiver connected to the processor; and
a memory for storing instructions executable by the processor;
wherein the processor is configured to load and execute the instructions to:
control the transceiver to transmit a configuration signaling to a first terminal, wherein the configuration signaling is used for configuring a transmission resource for sidelink control information and a transmission resource for a physical sidelink shared channel (PSSCH), and the transmission resource carrying the sidelink control information and the transmission resource carrying the PSSCH are based on an interlaced resource block (IRB).

18. The apparatus of claim 17, wherein the configuration signaling comprises first indication information, and the first indication information comprises an IRB index for determining a frequency domain starting position of the transmission resource carrying the sidelink control information.

19. The apparatus of claim 17, wherein the configuration signaling comprises second indication information for determining a first information field, and the first information field is used for determining an IRB index and/or a number of IRBs in the transmission resource carrying the PSSCH;
the IRB index is used for determining a frequency domain starting position of the transmission resource carrying the PSSCH; and
the number of IRBs is used for determining a frequency domain resource size of the transmission resource carrying the PSSCH.

20. The apparatus of claim 17, wherein the configuration signaling comprises downlink control information (DCI) signaling or a radio resource control (RRC) signaling.
